(19) United States
(12) Patent Application Publication
(10) Pub. No.: US 2015/0136059 A1
(43) Pub. Date: May 21, 2015

(54) PULL START ENGINE STARTER ASSISTANCE DEVICE

(71) Applicant: Gordon Mulligan, Lanark (GB)

(72) Inventor: Gordon Mulligan, Lanark (GB)

(21) Appl. No.: 14/499,103

(22) Filed: Sep. 27, 2014

(51) Int. Cl. F02N 3/04

(52) U.S. Cl. CPC F02N 3/04
USPC 123/185.1

(57) ABSTRACT

A kick start engine starter assembly is provided herein, which is a universally adaptable kick start device for use on most push mowers and other pull-start engines, allows a user the capability to pull start a hand start lawnmower with the assistance of the user's leg.

The invention relates generally to a device that converts a pull start engine to a kick start engine starter.

### BACKGROUND OF THE INVENTION

Currently there are a number of solutions for the purpose of allowing a person the capability to easily starter a lawnmower or other pull start engine. Some of these solutions attempt to sell lawnmowers with push button starters, but these solutions fail to meet the needs of the market because high costs and the tendency to malfunction over time. Other solutions attempt to feature a key start lawn mower, but these solutions are similarly unable to meet the needs of the market because keys can be lost or broken off in an ignition. Still other solutions seek to sell pull start mowers with the claim that the mower is easy to start, but these solutions over time also begin to fail.

Therefore, there currently exists a need in the market for a device that converts pull start engines to kick start engines that is easy to install and use.

### SUMMARY OF THE INVENTION

It would be advantageous to have a device for the purpose of allowing a user the capability to pull start a hand start lawnmower or other pull start engine with the assistance of the user's leg. Furthermore, it would also be advantageous to have a device that utilizes the pull cord of a hand start mower attached to a series of pulleys and a foot stirrup to start the motor. Still further, it would be advantageous to have a device with a universally adaptable kick start device for use on most push mowers or that can be transferred between different machines. Therefore, there currently exists a need in the market for a starting apparatus that is a universally adaptable kick start device for use on most push mowers that allows a user the capability to pull start a hand start lawnmower with the assistance of the user's leg or pull start without reaching down to retrieve the cord.

In an example embodiment, the starter device converts a pull start mower to a kick start mower starter. The device has one starter handle rest and one small pulley fitted to the top of the support arm, there is also one stirrup connected to a stabilizing arm with small pulley at top. The device utilizes the pull cord that most engines are equipped with without adaptation. The pull cord is also available for use by hand without disengaging the start device.

In an alternative embodiment, the device could be used to start gas engines on standby generators, boat motors, chainsaws, string trimmers, or other machines with pull start engines that are primarily on the ground when in use.

In an example embodiment, the device is easy to connect to a handle bar and allows the hand cord to be kept available for use at all times with or without the device. This allows the device to connect to the handle mechanism of most lawnmowers on the market without modification.

It is an advantage of the device to provide the ability to start a gasoline engine with the power of a user's legs and when the user lacks the power and/or speed in their arms.

The device now will be described more fully hereinafter with reference to the accompanying drawings, which are intended to be read in conjunction with both this summary, the detailed description and any preferred and/or particular embodiments specifically discussed or otherwise disclosed. This device may, however, be embodied in many different forms and should not be construed as limited to the embodiments set forth herein; rather, these embodiments are provided by way of illustration only and so that this disclosure will be thorough, complete and will fully convey the full scope of the invention to those skilled in the art.

### BRIEF DESCRIPTION OF THE DRAWINGS

FIG. 1. illustrates a perspective view of an example embodiment of a starter device or mechanism adapted for use on a gas start engine or mower; and

FIG. 2. illustrates another view of an example embodiment of the starter device or assembly.

### DETAILED DESCRIPTION OF THE INVENTION

Following are more detailed descriptions of various related concepts related to, and embodiments of, methods and apparatus according to the present disclosure. It should be appreciated that various aspects of the subject matter introduced above and discussed in greater detail below may be implemented in any of numerous ways, as the subject matter is not limited to any particular manner of implementation. Examples of specific implementation and applications are provided primarily for illustrative purposes.

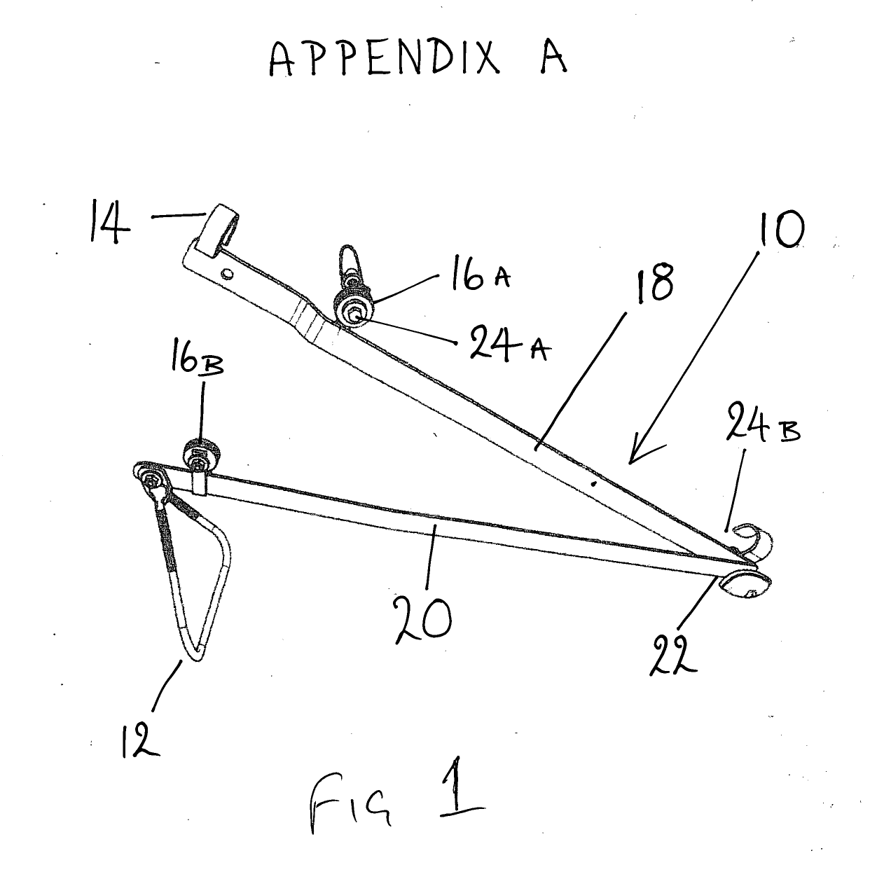

Referring now to the Figures, FIG. 1. illustrates a perspective view of an example embodiment of the starter device or assembly 10. The kick-starter assembly 10 has a fixed arm 18 and a movable arm 20 connected at pivot point 22. The movable arm 20 has a stirrup 12 connected at the end opposite the pivot point 22. The fixed arm 18 connects the handle or frame of a lawnmower (on the side of the pull cord) so that the kick-starter 10 is aligned as the pull-start cord is. A pull-start cord is woven through pulleys 16a and 16b so that the handle rests in start handle rest 14. Movable arm 20 is aligned with fixed arm 18 in a resting position, and when in use pivots at pivot point 22, by engaging the stirrup 12.

When a user desires to start a pull start engine, the user puts his foot in stirrup 12 and steps downwards. This action causes the movable arm 20 to pivot which pulls the pull-start cord to start an engine. Alternatively, a user may still pull the pull-start cord in the conventional manner without having to remove the kick-starter 10 and it provide the advantage of reaching the cord without bending down.

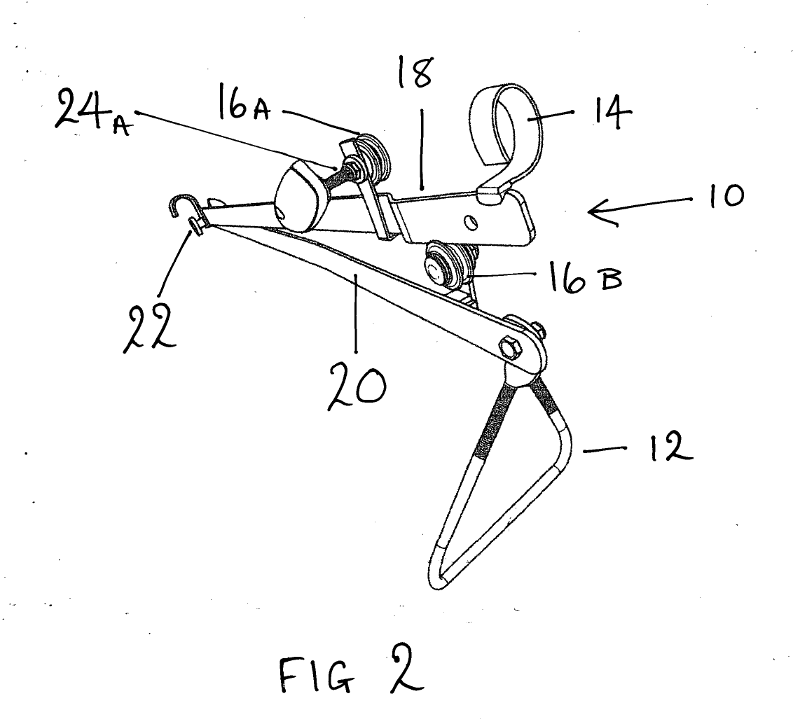

Referring now to FIG. 2, there is illustrated an alternative view of kick-starter 10. Kick-starter 10 has a fixed arm 18 with a starter handle rest 14 on one end and a pivot point 22 at an opposite end. A movable arm 20 is connected to pivot point 22 at one end and has a stirrup 12 at an opposite end. Moveable arm 20 and fixed arm 18 each have a pulley 16a, 16b. A pull-start cord is woven through kick-starter 10 by resting cord over pulley 16a, under pulley 16b, and is contained in starter handle rest 14.

In an example embodiment, kick-starter 10 has two attachment points 24a, 24b to attach to the handle of a lawnmower. Attachment points (or pins) 24a, 24b are capable of attaching to a handle through existing screw holes, or with the use of brackets (not shown) or clamps. Attachment points 24a, 24b allow for easy attachment and removal of kick-starter 10 so it may be used on multiple machines. Kick-starter 10 also is capable of working with existing pull-start engine cords.

A method is also taught herein for starting a gas powered mower or engine or motor that utilizes a starter assembly which converts a pull start engine to a kick start engine starter, while still maintaining the option to pull start the engine. The starter assembly is placed on the frame of the frame of the mower, for instance, which one starter handle rest and one small pulley fitted to the top of the support arm, there is also one stirrup connected to a stabilizing arm with small pulley at top. The existing pull cord that most engines are equipped with is used without adaptation. The pull cord is then routed through a series of pulleys and engages the foot stirrup, while the handle is mounted in a hand rest. The pull cord is also available for use by hand without disengaging the said device.

Various related embodiments of the invention are also described in Appendix A, Which is incorporated herein by reference in its entirety. The following patent is incorporated by reference in its entirety; U.S. Pat. No. 5,762,037.

While the invention has been described above in terms of specific embodiments, it is to be understood that the invention is not limited to these disclosed embodiments. Upon reading the teachings of this disclosure many modifications and other embodiments of the invention will come to mind of those skilled in the art to which this invention pertains, and which are intended to be and are covered by both this disclosure and the appended claims. It is indeed intended that the scope of the invention should be determined by proper interpretation and construction of the appended claims and their legal equivalents, as understood by those of skill in the art relying upon the disclosures in this specification and the attached drawings.

1. A pull start engine starter device as substantially described and depicted herein.

2. A lawnmower starter attachment device as substantially described and depicted herein.
